(19) United States
(12) Patent Application Publication
(10) Pub. No.: US 2009/0040948 A1
(43) Pub. Date: Feb. 12, 2009

(54) Speed conferencing

(75) Inventors: Michael S. Wengrovitz, Concord, MA (US); Mark A. Kelley, Brentwood, NH (US)

Correspondence Address: GARLICK, HARRISON & MARKISON (ALU), P.O. BOX 160727, AUSTIN, TX, 78716-0727, US

(73) Assignee: ALCATEL LUCENT, Paris (FR)

(21) Appl. No.: 12/172,234

(22) Filed: Jul. 13, 2008

Related U.S. Application Data
(60) Provisional application No. 60/954,697, filed on Aug. 8, 2007.

(51) Int. Cl. H04L 12/16

(52) U.S. Cl. 370/260

(57) ABSTRACT

Speed conferencing is facilitated using a speed conference group. A conference server provides a conference room for managing a conference call between conference participants belonging to the speed conference group. The conference server uses the speed conference group to call the conference participants within that speed conference group to invite the conference participants to join the conference call in the conference room.

### CROSS-REFERENCE TO RELATED APPLICATIONS

This U.S. Nonprovisional application for patent claims the benefit of the filing date of U.S. Provisional Patent Application entitled, SPEED CONFERENCING, Attorney Docket No. 802104P, having Ser. No. 60/954,697, filed on Aug. 8, 2007, which is incorporated herein by reference for all purposes.

### BACKGROUND OF THE INVENTION

1. Technical Field of the Invention

The present invention relates in general to communications systems, and in particular, to conferencing systems.

2. Description of Related Art

Rapid establishment of voice communication sessions is an important requirement in modern telephony systems. People are no longer content to wait 20-30 seconds to dial a rotary telephone, or to talk with an operator in order to setup a call. Today, with the advent of buddy lists and contact lists, a user can set up a call by simply pressing a single button and almost immediately receiving the ring-back signal from the called party.

The act of depressing a single speed key on a user's cell phone, PBX phone, or POTS phone to call a particular contact is often referred to as “speed dialing.” An advantage of speed dialing is that the user does not need to remember the ten or more digit telephone number of the contact, since this is already preprogrammed into the contact or buddy list. Another advantage of speed dialing is that the user does not need to spend the time entering the long digit-string into his or her phone. Instead, a simple push of a single button sets up the call between the two users.

However, speed dialing is only able to set up a voice conversation between two parties, the single caller and the single callee. In some cases, a voice conversation between several or perhaps even numerous parties may be desired. For example, in enterprise business scenarios, people typically work on teams, and therefore, there may be a business need for the rapid establishment of multiparty voice calls to meet each team's business objectives. First-responder, emergency and government applications may also require multiparty conference calls between members of a team. In addition, multiparty calls may also be desired in consumer applications, as evidenced by the prevalence of multiparty instant message chat sessions.

Therefore, many service providers offer a voice conference call service in which a group of people can simultaneously communicate with each other. Typically, in such conferencing systems, each user is provided a 10 or more digit dial-in number plus a 7 or more digit access code to join the conference. After dialing the dial-in number, interacting with an Interactive Voice Response (IVR) system, and entering the additional access code digits, each of the multiple callers are bridged together so that they are able to speak to and hear each other within a conference room. However, the process of joining each user separately to a conference call takes time. Furthermore, conventional conference bridge systems typically require coordination and scheduling between users. For example, the team must dial-in to the conference bridge at a certain, specific agreed-upon time. Thus, in addition to being inconvenient for all users due to entry of a large number of DTMF digits, conventional conference bridges do not facilitate spontaneous, ad-hoc voice conferences, which may be required in many enterprise, consumer and emergency communication scenarios.

Recently, some service providers have begun to offer a special multiparty voice service referred to as group push-to-talk. A user having a special type of cell phone, who also purchases a special group push-to-talk service from the service provider, can engage in a group push-to-talk voice communication by depressing a single key to speak to another user. However, the other user must also have the same special type of cell phone and same special service from the same service provider. Thus, a major limitation of this walkie-talkie-like system is that all users must have the same special cell phone devices and the same service provision. Other users having standard non-special cell phones, PBX phones and POTS phones cannot participate in the call. Furthermore, group push-to-talk systems do not truly set up persistent conference calls. In the currently available push-to-talk service, only a single person can speak at any one time, and coordination or protocol is required in order to establish who is allowed to speak next, i.e. which single user is allowed to depress his/her group Push-to-Talk button on the special set.

As such, what is needed is a system that facilitates the rapid establishment of spontaneous multiparty voice conference calls.

### SUMMARY OF THE INVENTION

A conference server, in one embodiment of the present invention, allows for the rapid establishment of spontaneous multiparty voice conference calls using a predefined speed conference group of conference participants. The conference server includes a conference room for managing a conference call between the conference participants of the speed conference group. In response to an event, such as one of the conference participants dialing into the conference server, the conference server dials out to all of the other conference participants within the speed conference group to invite the conference participants to join the conference call in the conference room.

In a further embodiment, a conferencing controller in communication with the conference server maintains a list of user identifications identifying at least a portion of the conference participants within the speed conference group. The conferencing controller provides the user identifications to the conference server to enable the conference server to call the conference participants to invite them to join the conference call.

In an exemplary embodiment, the conference server receives from a first conference participant, a user identification identifying the first conference participant. The conferencing controller compares the user identification of the first conference participant with the list. If the user identification of the first conference participant is within the list, the conferencing controller provides an instruction to the conference server to call the other conference participants within the speed conference group. If not, and if a group identifier identifying the speed conference group is received from the first conference participant, the conferencing controller provides an instruction to the conference server to call each of the conference participants within the speed conference group and join the first conference participant and the conference participants within the speed conference group to the conference call.

In another exemplary embodiment, a predefined conference room identifier that identifies the conference room associated with the speed conference group is received from the first conference participant. The conferencing controller maintains a list of conference room identifiers, each being associated with a different one of a plurality of speed conference groups. The conference server provides the predefined conference room identifier to the conferencing controller upon receipt thereof from the first conference participant, and the conferencing controller provides a third instruction to the conference server to create the conference room based upon the predefined conference room identifier.

A system, in another embodiment of the present invention, facilitates speed conferencing using a conference server and a conferencing controller. The conference server includes a conference room operable to manage a conference call between conference participants, in which at least a portion of the conference participants belong to a speed conference group. The conference server creates the conference room and calls the conference participants within the speed conference group to invite the conference participants to join the conference call. The conferencing controller maintains the speed conference group. The speed conference group includes a list of user identifications identifying at least a portion of the conference participants within the speed conference group. The conferencing controller further provides an instruction to the conference server to call the conference participants within the speed conference group using the respective user identifications associated therewith.

A method, in yet another embodiment of the present invention, facilitates speed conferencing by provisioning a speed conference group including conference participants. Upon receiving an incoming call from a first one of the conference participants, a conference room for a conference call involving the conference participants of the speed conference group is created, the other conference participants within the speed conference group are called to invite them to join the conference call and both the first conference participant and the other invited conference participants are joined to the conference call via the conference room.

### BRIEF DESCRIPTION OF THE DRAWINGS

A more complete understanding of the present invention may be obtained by reference to the following detailed description when taken in conjunction with the accompanying drawings wherein:

FIG. 1 illustrates an exemplary speed conferencing system, in accordance with embodiments of the present invention;

FIG. 2 illustrates an exemplary conference server for use in the speed conferencing system, in accordance with embodiments of the present invention;

FIG. 3 illustrates an exemplary speed conferencing flow diagram, in accordance with embodiments of the present invention;

FIG. 4 illustrates an exemplary operation of a conference room within the conference server, in accordance with embodiments of the present invention; and

FIG. 5 is a flowchart illustrating an exemplary process for facilitating speed conferencing, in accordance with embodiments of the present invention.

### DETAILED DESCRIPTION OF THE DRAWINGS

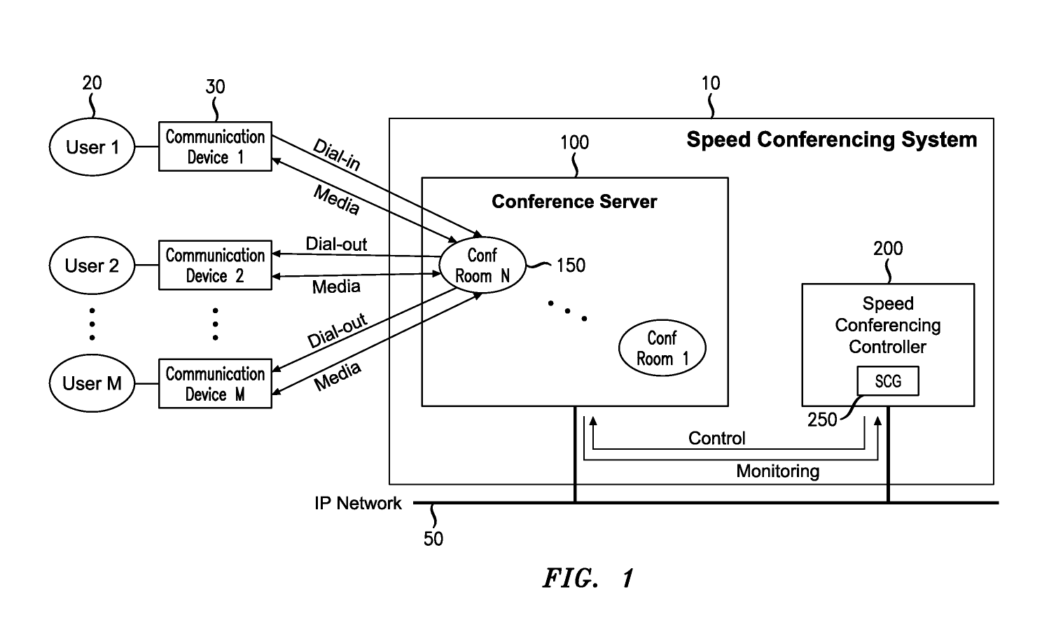

FIG. 1 illustrates an exemplary speed conferencing system 10, in accordance with embodiments of the present invention. The speed conferencing system 10 allows persistent multiparty calls to be set up between users 20 having different types of communication devices 30. For example, such communication devices 30 can include plain old telephone service (POTS) phones, cell phones, Session Initiation Protocol (SIP) phones, desktop phones, PBX phones, desktop computers, laptop computers, Portable Digital Assistants (PDAs) and LMR radios.

The speed conferencing system 10 includes a voice/data conference server 100 providing one or more conference rooms 150 for conference calls. Each conference room 150 is associated with a particular conference call, and is responsible for establishing the different conference legs to/from each of the conference participants (users 20) for the conference call and for managing the leg states of the conference legs. For example, the conference room 150 can establish a respective conference leg for each voice and data connection to the conference call, add additional voice and/or data conference legs to the conference call, drop one or more voice and/or data conference legs and mute or un-mute one or more of the voice conference legs.

As shown in FIG. 1, multiple conference rooms 150 can exist in parallel. However, voice between conference rooms 150 is not mixed (unless directed by an operator), so that participants in one conference room 150 do not unintentionally hear participants in another conference room 150.

In one embodiment, the conference server 100 creates and manages the conference rooms 150 in specialized conferencing hardware or circuitry. In another embodiment, the conference server 100 creates and manages and conference rooms 150 using a combination of specialized conferencing hardware or circuitry, software and/or firmware. In yet another embodiment, the conference server 100 executes software routines on a standard, general-purpose personal computer (PC) to create and manage the conference rooms 150. In this embodiment, the conference server 100 is designed to enable additional separate general-purpose PCs to be stacked together for increased system scalability and redundancy. As such, no special hardware or circuitry, such as DSP chips and boards and high speed audio busses, is required, thereby minimizing manufacturing costs of the conference server 100.

The telephony connections for exchanging media between the communication devices 30 and the conference server 100 can utilize either packet-switched connections, such as Voice over Internet Protocol (VoIP), e.g., Session Initiation Protocol (SIP), or circuit-switched connections, such as Integrated Services Digital Network (ISDN), e.g., Primary Rate Interface (PRI) trunks. For example, the conference server 100 can exchange SIP commands and VoIP Real Time Protocol (RTP) media with an external SIP-to-PSTN gateway, SIP phones, and other SIP devices, such as SIP-to-Radio converters, SIP overhead speakers, etc. The conference server 100 can also incorporate, or interface to, an internal or external T1/E1 telephone trunk card for the exchange of voice signaling and media via the Public Switched Telephone Network (PSTN) with conventional POTS, PBX, and cell phones.

The speed conferencing system 10 also supports a network-based control and monitoring interface over an IP or other packet-based network 50. For example, the data network 50 can be a local area network (LAN), wide area network (WAN), privately managed IP data network, an Internet-based virtual private network (VPN) that uses well-established secure data encryption and authentication methods, such as IPSEC, or a public Internet-based IP data network.

An external speed conferencing controller 200 can authenticate with the conference server 100 over the IP network link 50, and then issue suitable Application Programming interface (API) commands to the conference server 100 to dial-out users, drop users from a specific conference room, mute users, etc. Monitoring information can also flow over the conference server's 100 network link 50, so that the speed conferencing controller 200 is asynchronously notified when users join conferences, enter DTMF digit sequences, leave conferences, etc. However, in other embodiments, the conference server 100 and speed conferencing controller 200 may also be combined within the same software or hardware-based appliance. As used herein, the term “controller” refers any device, system or part thereof that controls at least one operation, which can be implemented in hardware, software, firmware, or some combination of the above. It should be noted that the functionality associated with the controller may be centralized or distributed, whether locally or remotely.

In contrast to traditional conference bridges typically designed to receive only dial-in calls, the speed conferencing system 10 supports both dial-in to and dial-out from the same conference room, which enables the rapid establishment of conference calls. Such bi-directionality is illustrated in FIG. 1, where a first user (User 1) has dialed into a particular conference room 150 (Conference Room N), and that conference room (Conference Room N) has dialed out to other users (User 2 . . . User M). It should be noted that all users 20 are provided with two-way media communication via the conference room 150. The bi-directionality property of the conference server 100 does not relate to the direction of media flow, but rather to how the call is setup.

The bi-directionality of the speed conferencing system 10 is implemented by using speed conferencing groups (SCGs) 250. A speed conferencing group (SCG) 250 is a predefined list of users that are to be included in a particular conference call. The SCG's 250 are maintained by the speed conferencing controller 200. To initiate a speed conference call for a particular SCG, the speed conference controller 200 provides the list of users for the particular SCG to the conference server 100 to enable the conference server 100 to dial-out to the users in the SCG and attempt to join these users to the speed conference call.

In one embodiment, each SCG list includes telephone numbers of users that are to be called for a particular conference call. In another embodiment, each SCG list includes multiple telephone numbers for each conference participant. For example, the speed conference system 10 can try a first number for a participant, such as his/her cell phone, and if the participant does not answer at the first number, then a second number, such as an office phone and then perhaps a third number, such as a home phone, in an attempt to reach that conference participant.

In yet another embodiment, each SCG list includes usernames of users that are to be called for a particular conference call. In this embodiment, the speed conferencing controller 200 can query a database within the speed conferencing controller 200 or the conference server 100 that maps the usernames to pre-registered telephone numbers, and then issue a dial-by-number command to the conference server 100. Each user can manage his/her username to telephone number mapping.

As an example, consider three users Alice, Bob, and Charlie in an SCG group. Alice has previously logged in and set her registered phone as 781-123-4567, Bob has previously logged in a set his registered phone as 781-123-5678 and Charlie has previously logged in and set his registered phone as 781-123-6789. To initiate a speed conference call for this SCG, the speed conferencing controller 200 looks up the current telephone numbers for each of the users in this SCG, and initiates calls from the conference server 100 to 781-123-4567, 781-123-5678 and 781-123-6789. If, sometime later, Alice decides to change her registered telephone number, Alice can log into the system 10 and enter a new number of 781-555-1212. The next time a speed conference call is initiated for the SCG, Alice is dialed out by the conference room to her new number. Therefore, users never need to know or manage other user's telephone numbers.

In general, a speed conference call is initiated when a particular user (User 1) 20 enters a conference room 150 associated with a particular speed conference group (SCG) 250. In one embodiment, the user enters a speed conference room 150 by dialing a main number for the conference server 100, and then entering an access code that designates a particular conference room 150 for the SCG. The user might also have a speed dial key programmed on his/her standard cell phone, POTS phone or PBX phone that contains the main number, plus some pause characters, plus the access code. In another embodiment, the conference server 100 might be designed so as to receive calls from many different DID (dialed-in) numbers, and the conference room to be entered is designated by the particular DID number itself For example, if the call is a SIP call, the SIP proxy might use an alias to convert the dialed-in number such as 781-897-1234 to a special SIP URI, such as To: session_{—}0183461, where the code 0183461 designates the conference room number for the SCG 250.

In yet another embodiment, a user operator can provide the instruction to the conference server 100 via a graphical user interface (GUI) on their communication device 30 that provides a conference application program interface (API) to the conference server 100. It should be understood that the present invention contemplates a number of different embodiments and variations for how the first conference participant enters a specific conference room 150, and only a few of them are described herein.

Once the first user enters a conference room 150 for a SCG 250, the conference room 150, based on instructions received from the speed conferencing controller 200 and/or based on internal policies stored within the conference server 100, dials out to the other users (User 2 . . . User M) in the SCG 250 to invite the other users to join the conference call. Once the other users accept the invitation to join the conference call, the conference room 150 establishes a separate conference leg for each voice and data connection for each user to the conference call.

During the conference call, the conference room 150 operates to mix incoming voice (or Voice over Internet Protocol (VoIP) media streams) received from the conference participants and transmit the mixed media streams back out to the conference participants and provide various data conferencing services to the conference participants during the conference call, such as instant messaging, presentation sharing, desktop sharing and video. In conjunction with the speed conferencing controller 200, the conference room 150 also implements various policies for managing the conference legs of the conference call, such as muting or un-muting one or more participants and adding and/or dropping one or more participants, based on, for example, a pre-determined time of release, occurrence of an event or action of another participant, etc.

In an exemplary scenario, when a first user (User 1) dials into the conference server 100 and enters a conference room (Conference Room N), for example by entering the access code corresponding to this conference room 150, the speed conferencing controller 200 is informed via notification events it receives across the IP link 50. Typical notification events contain the caller-ID (or the SIP From: header if the caller is a SIP device) as well as the unique number or identifier associated with the specific conference room entered by the caller (User 1).

If User 1 has entered a conference room for which there exists a pre-provisioned Speed Conference Group (SCG), the speed conferencing controller 200 then refers to the caller-ID for User 1 and compares it to the list of numbers in the pre-provisioned SCG 250. If the caller-ID number matches one of the numbers in the SCG 250 for this conference room 150, the speed conferencing controller 200 issues one or instructions to the conference server 100 to dial-out to all other users in the SCG, i.e. all other numbers that differ from the caller-ID of User 1. If User 1's caller-ID does not match any of the numbers in the SCG 250 for this conference room, the entire set of numbers in the SCG list are called.

However, if User 1 enters a conference room for which no SCG exists, the speed conferencing controller 200 takes no action and issues no further commands to the conference server 100 for this conference room. However, the speed conferencing controller 200 continues to monitor the conference server 100 for callers who may be entering other conference rooms for which SCGs do exist. Similarly, if a caller dials into a conference room for which an SCG exists, but this caller is not the first caller, i.e. there is at least one other party already present in this conference room, the speed conferencing controller 200 takes no action, since the conference is already active.

In an exemplary embodiment, the users in a SCG 250 dialed out by the conference server 100 initially receive an interactive voice response (IVR) prompt, such as “You have been invited to a Group 123 conference, please press 1 to join, or press 2 to decline,” where Group 123 is a tag or identifier associated with the SCG 250. In this way, called users may know which Speed Conference Group they are about to enter. In general, users may belong to one or more Speed Conference Groups. After receiving this IVR message, each user who depresses 1 is immediately joined to the conference room associated with the speed conference call. All audio associated with each dialed-out leg is preferably muted until the called user accepts the call by pressing 1. Therefore, other users, including the first user already present in the speed conference, do not hear distracting superfluous sounds in the conference room, such as answering machine prompts, continuous ringing, busy signals, etc. In one embodiment, all users in the speed conference hear a single beep sound immediately after each other called party joins the conference by pressing 1. In another embodiment, users enter the call silently.

In accordance with further embodiments of the present invention, when dialing-out to other users, the conference server 100 can place multiple calls in parallel rather than sequentially. That is, instead of calling each user and waiting for the answer and acceptance, the conference server 100 calls all the users in the SCG 250 at the same time, and as each user answers and accepts the call, he/she is joined to the conference.

In some cases, the called user may not be able to answer the call and instead the call is directed to voicemail. Eventually, when the user checks his email, he hears the prompt: “You have been invited to a Group 123 conference, please press 1 to join, or press 2 to decline”. If the user knows the dial-in access code associated with the Group 123 conference room, he/she is able to dial back in and join the already-active conference. However, if the user calls back and this conference has ended (e.g., the conference room is empty), he/she will become the first-party in the new conference. In one embodiment, the speed conferencing controller 200 reinitiates the speed conference to all other members of the Group 123 SCG. In another embodiment, the speed conferencing controller 200 issues a different prompt to the first caller, stating, “You are the first party in this Group 123 conference, please enter 1 to initiate a Speed Conference,” thereby giving the caller the opportunity to initiate the speed conference or not. As another example, the speed conferencing controller 200 can wait for configurable period of time, such as 10 seconds, allowing the first caller to quickly hang up and abort initiation of the speed conference.

In the embodiments discussed above, the event that triggers the speed conference is a first user dialing in. However, other types of events can also trigger a speed conference. For example, rather than initiating the dial-out of the SCG list after the first user joins the conference room associated with the SCG 250, the system might instead react to DTMF commands issued by a participant already in another conference room. In this embodiment, there may be one or more users already in a particular conference room, and one of these users can interact with an IVR to initiate the speed conference process. For example, the user might enter ##5, and receive an IVR prompt stating “Please enter the Speed Conference number”, and after the user entered a particular SCG number, the appropriate SCG list corresponding to that number would be dialed.

As another example, a click or double-click on an icon displayed on a PC or a touch-screen display might trigger the initiation. Or, a physical event, such as contact closure, sensor detection, threshold crossing, etc., initiated by an alarm subsystem, building monitoring system, or any other physical or logical system event could cause the speed conference to occur. In an exemplary embodiment, the voice message delivered to each called party would also indicate the nature of the alarm, so that the called parties are aware of the alarm prior to depressing the DTMF 1 key to join the speed conference to discuss the event.

The SCG may also be coupled to an email or SMS messaging system (not shown). For example, if an email or SMS containing authentication credentials is received by the speed conferencing controller 200, a speed conference might then be initiated to one or more SCGs 250. Similarly, when a speed conference is initiated, SMS messages or emails might also be sent to the users within the SCG. In this way, if a called party was not able to join, he/she would receive an SMS and/or email so that they could dial back in to the conference shortly thereafter.

In other embodiments, the SCG 250 is determined in ways other then linkage to a specific conference room number. For example, the SCG 250 can be determined based the caller-ID of the first caller. For example, if the caller-ID is a member of SCG1, SCG1 is called, whereas if the caller-ID is a member of SCG2, SCG2 is called. In another embodiment, the SCG to be called can depend upon other factors including time, day, etc. For example, during the daytime in a hospital ward, the speed conference system 10 might call Nurse1 on daytime duty and Supervisor1 on daytime duty, whereas during the nighttime the same speed conference might call Nurse2 on nighttime duty and Supervisor2 on nighttime duty. In another embodiment, the SCG to be called can depend upon participant requirements. For example, a usage case in an emergency context may be that the speed conference system 10 keeps trying numbers until a representative of the mayor's office, two representatives of the police department, and three representatives of the fire department are all present in the conference room.

In addition, the call list may also depend upon the success history of past calls. For example, if the speed conference system 10 called Users 2-5 and User3 did not answer and accept the call, the speed conferencing controller 200 may have a set of rules for whom to call next, such as User3's assistant or delegate. In this fashion, the speed conference system 10 can keep calling different numbers until an acceptable roster of participants is achieved, or until some configurable time interval has expired.

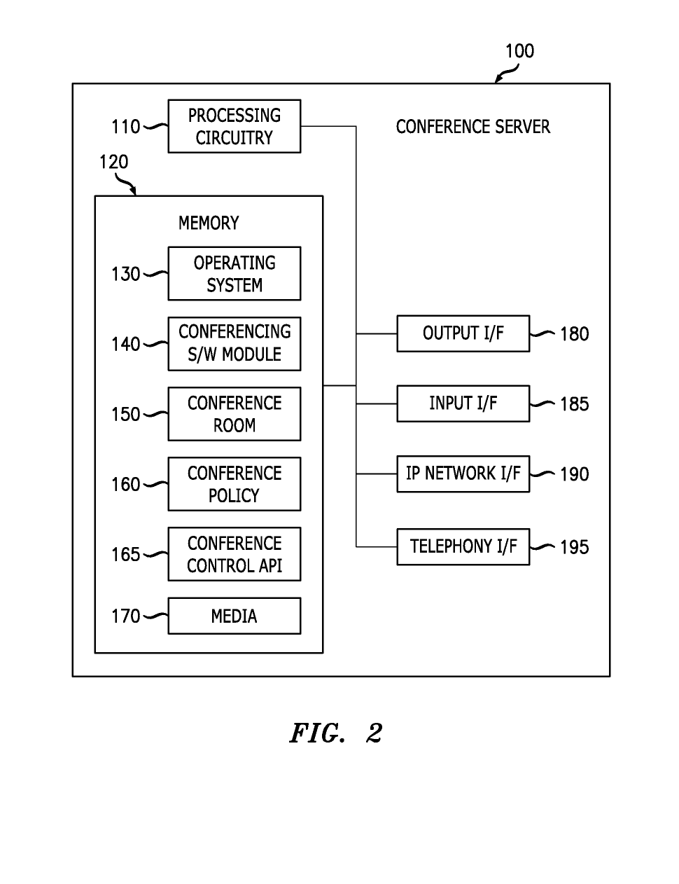

Referring now to FIG. 2, the conference server 100 will now be described in more detail. The conference server 100 includes processing circuitry 110, a memory 120 and various interfaces 180, 185 and 190. For example, to check the status of the conference server (e.g., troubleshoot problems, receive status reports, etc.), the interfaces can include an input interface 185 coupled to receive input from an input device, such as a keyboard, mouse, IP network or other similar input device and an output interface 180 coupled to provide status information to an output device, such as a display, speakers, printer, IP network or other output device. In addition, an IP network interface 190 is connected to transmit and receive control and monitoring information to and from the speed conferencing controller. A telephony interface 195 is also connected to transmit and receive media (e.g., circuit-switched voice, VoIP media streams and/or data) to and from user communication devices. As described above, the telephony interface 195 can includes one or more of a packet-switched I/F for transmitting VoIP media, or a circuit-switched I/F for transmitted circuit-switched voice.

As shown in FIG. 2, the memory 120 includes an operating system 130 and a conferencing software module 140. Thus, the processing circuitry 100 includes one or more processors that are capable of executing the operating system 130 and the conferencing software module 140. As used herein, the term “processor” is generally understood to be a device that drives a general-purpose computer, such as a PC. It is noted, however, that other processing devices, such as microcontrollers, Field Programmable Gate Arrays (FPGAs), Application Specific Integrated Circuits (ASICs), or a combination thereof, can be used as well to achieve the benefits and advantages described herein. The memory 120 includes any type of data storage device, including but not limited to, a hard drive, random access memory (RAM), read only memory (ROM), flash memory, compact disc, floppy disc, ZIP® drive, tape drive, database or other type of storage device or storage medium.

In a general operation of the conference server 100, the processing circuitry 110 accesses and runs the conferencing software module 140 to initiate and control a conference call between multiple participants. For example, during execution of the conferencing software module 140, the processing circuitry 110 is operable to receive instructions for creating and managing a conference room 150 for a speed conference call via a conference control application program interface (API) 165 that is communicatively coupled to receive input from conference participants via the telephony I/F 195 and to receive input from the speed conferencing controller via the IP Network I/F 190. The conference room 150 receives incoming media (e.g., circuit-switched voice, VoIP media streams and/or data) from the conference participants via telephony I/F 195, processes the received media using the processing circuitry 110 and transmits the processed media 170 (e.g., mixed voice and/or data) back out to the conference participants during the conference call.

In addition, the conference room 150 and/or processing circuitry 110 can access one or more conference policies 160 to control and/or manage the conference call. Once accessed, the processing circuitry 110 performs routines dictated by the policies 160. The conference policies 160 may be predefined or received from one of the conference participants or the speed conferencing controller via the conference control API 165. For example, in an exemplary embodiment, a policy 160 may identify one or more conference participants to be included in the conference call. In another exemplary embodiment, the policy 160 may control muting or un-muting of one or more participants during the conference call.

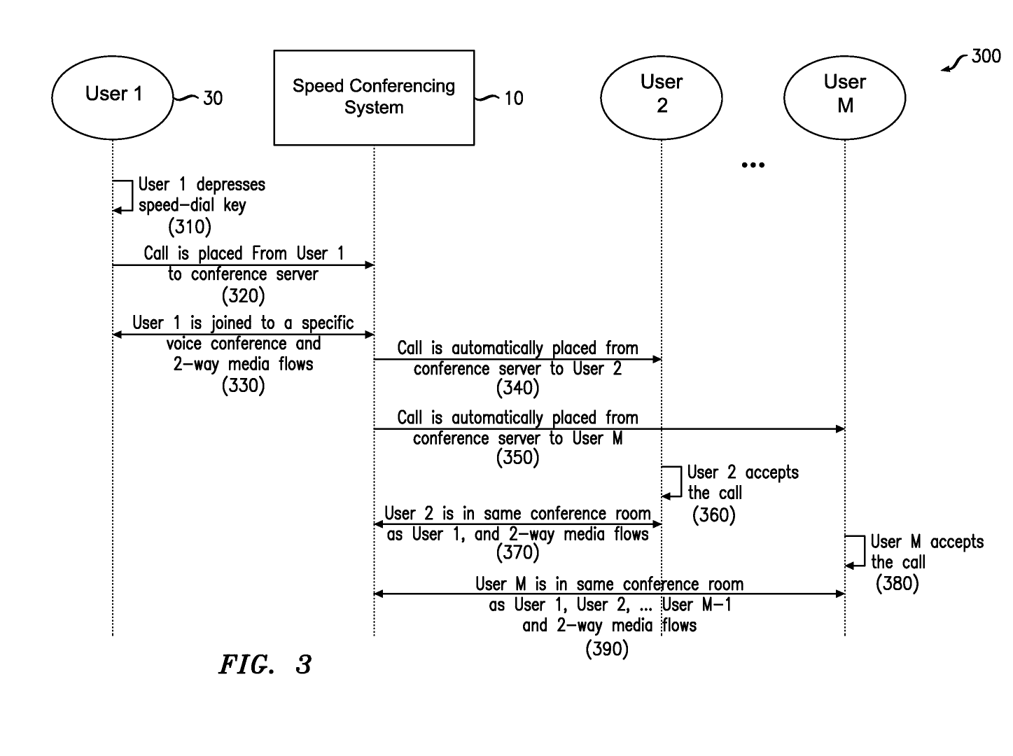

FIG. 3 illustrates an exemplary speed conferencing flow diagram, in accordance with embodiments of the present invention. To initiate a speed conference, at 310, a first user (User 1) 30 depresses a speed-dial key on his/her communication device, which, at 320, causes the communication device to place a call from User 1 to the conference server of the speed conferencing system 10. The speed-dial number either includes the conference room number for the speed conference or is a particular DID for the speed conference call. At 330, User 1 is joined to a specific speed voice conference associated with a particular speed conference group (SCG) and two-way media begins to flow. At 340 and 350, the speed conferencing system 10 automatically places outgoing calls from the conference server to other members of the SCG, in particular, User 2 . . . User M, to invite the other members of the SCG to join the speed conference call. At 360, User 2 accepts the invitation to join the call (e.g., by depressing one or more DTMF digits on his/her communication device or providing a voice response to an IVR system associated with the speed conferencing system 10). Thereafter, at 370, User 2 is placed in the same conference room as User 1 and two-way media begins to flow between User 1 and User 2 via the conference room. Finally, at 380 and 390, User M accepts the invitation to join the speed conference call, and two-way media begins to flow between User 1, User 2 . . . User M via the conference room.

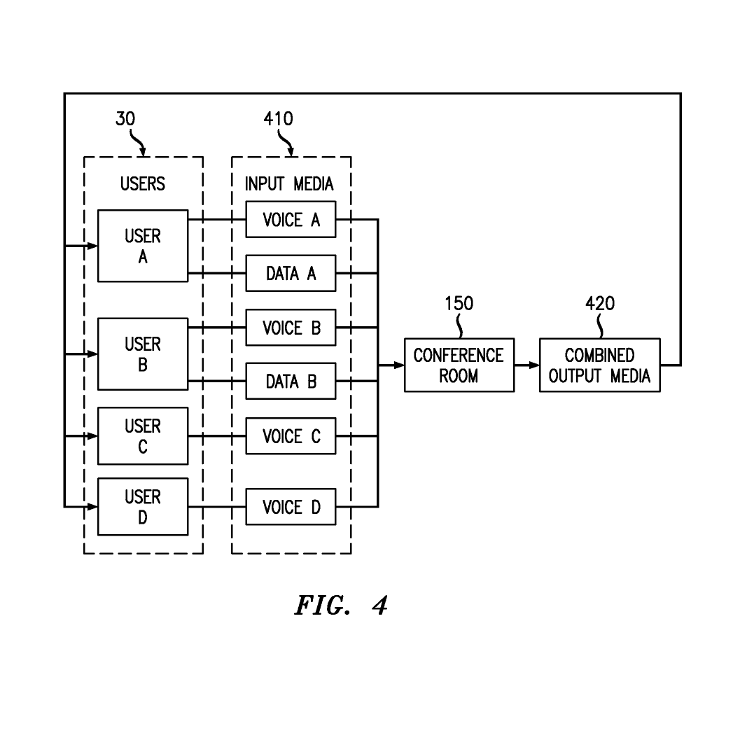

FIG. 4 illustrates an exemplary voice mixing operation of a conference room 150 in accordance with embodiments of the present invention. In FIG. 4, multiple participants 30 (A, B, C and D) are engaged in a conference call via the conference server 100 and are coupled to transmit input media 310 to the conference room 150 and receive output media 320 from the conference room 150. Participants A and B have both a voice connection (voice conference leg) and a data connection (data conference leg) to the conference room 150, while Participants C and D have only a voice connection (voice conference leg) to the conference room 150. Thus, Participant A is capable of transmitting both voice (Voice A) and data (Data A) to the conference room 150, Participant B is capable of transmitting both voice (Voice B) and data (Data B) to the conference room 150, Participant C is capable of transmitting voice (Voice C) to the conference room 150 and Participant D is capable of transmitting voice (Voice D) to the conference room 150.

As described above, the conference room operates to combine the input media received from all participants 300 and transmit the combined media 320 back out to the participants. For example, if during the conference call, the conference room 150 simultaneously receives voice from Participant A (Voice A) and Participant D (Voice D), the conference room 150 mixes the voice and transmits the mixed voice back out to Participants B and C. To avoid echos, the conference room 150 transmits only the voice from Participant D to Participant A and transmits only the voice from Participant A to Participant D. Likewise, if the conference room 150 receives both voice (Voice A) and data (Data A) from Participant A, the conference room will transmit both the voice (Voice A) and data (Data A) to Participant B, while transmitting only the voice (Voice A) to Participants C and D.

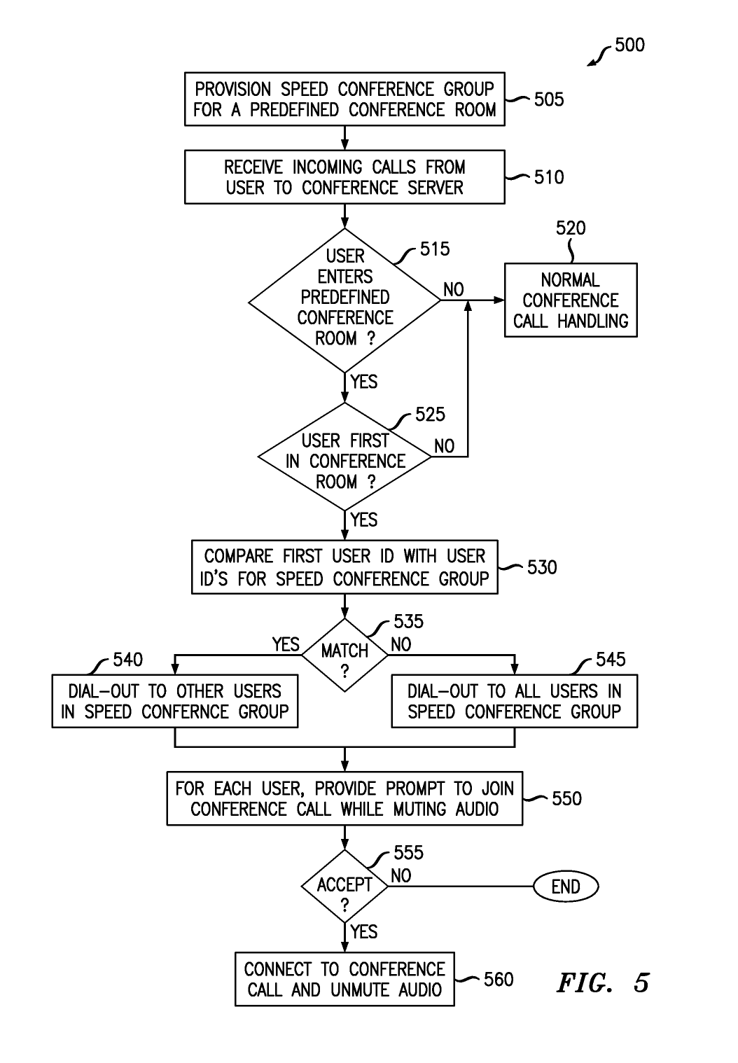

FIG. 5 is a flowchart illustrating an exemplary process 500 for facilitating speed conferencing, in accordance with embodiments of the present invention. The process begins at block 510, where a speed conference group including a list of users is provisioned for a predefined conference room. At block 510, an incoming call from a particular user is received at a conference server. If, at block 515, the user does not enter the predefined conference room, normal conference call handling is applied at block 520. However, if at block 515, the user does enter the predefined conference room, a determination is made at block 525 whether the user is the first user in the conference room. If not, the process resumes at block 520, where normal conference call handling is applied to the incoming call.

However, if the user is the first user in the predefined conference room, at block 530, the user ID (e.g., caller ID) of the first user is compared with the user ID's of all of the users listed in the SCG for the predefined conference room. If, at bock 535, the user ID of the first user matches one of the user ID's in the SCG, at block 540, the conference server dials-out to all of the other users in the SCG. However, if the user ID of the first user does not match any of the user ID's in the SCG, at block 545, the conference server dials-out to all of the users in the SCG.

At block 550, for each user called, the conference server provides a prompt to invite the user to join the conference call while muting the audio between the user and the predefined conference room. At block 555, for each user that accepts the invitation to join, at block 560, that user is connected to the conference call in the predefined conference room and the audio between the user and the predefined conference room is un-muted.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

We claim:

1. A conference server that facilitates speed conferencing, comprising:
a conference room operable to manage a conference call between conference participants, at least a portion of said conference participants belonging to a speed conference group; and
processing circuitry coupled to said conference room and operable to create said conference room;
wherein, upon the occurrence of an event, said processing circuitry is further operable to call said conference participants within said speed conference group to invite said conference participants to join said conference call.

2. The conference server of claim 1, further comprising:
at least one network interface coupled to said conference room and coupled to at least one network over which media is transmitted and received between said conference participants via said conference room.

3. The conference server of claim 2, wherein said media includes one or more of voice, text and multi-media.

4. The conference server of claim 1, further comprising:
a conferencing software module executable by said processing circuitry to create and manage said conference room; and
a memory device within which said conference room is created.

5. The conference server of claim 1, further comprising:
a conferencing controller operable to maintain said speed conference group, said speed conference group including a list of user identifications identifying at least a portion of said conference participants within said speed conference group;
wherein said conferencing controller provides said user identifications to said conference server to enable said conference server to call said conference participants within said speed conference group to invite said conference participants to join said conference call.

6. The conference server of claim 5, wherein said user identifications include at least one of user names and user telephone numbers, each of said user names being mapped to at least one of said user telephone numbers.

7. The conference server of claim 5, wherein:
said event includes receiving an incoming call from a first one of said conference participants;
said processing circuitry is operable to receive a first user identification from said first one of said conference participants and to provide said first user identification to said conferencing controller; and
said conferencing controller is further operable to compare said first user identification with said list to determine whether said first user identification is within said list, and if so, provide a first instruction to said processing circuitry to call other ones of said conference participants within said speed conference group using said respective user identifications associated therewith to join said other ones of said conference participants to said conference call with said first one of said conference participants.

8. The conference server of claim 7, wherein:
said processing circuitry is further operable to receive a group identifier identifying said speed conference group from said first one of said conference participants and to provide said group identifier to said conferencing controller;
said conferencing controller is further operable to use said group identifier to access said list; and
said conferencing controller is further operable to provide a second instruction to said processing circuitry to call each of said conference participants within said speed conference group using said respective user identifications associated therewith when said first user identification is not within said list to join said conference participants within said speed dial group and said first one of said conference participants to said conference call.

9. The conference server of claim 8, wherein:
said group identifier is a predefined conference room identifier that identifies said conference room associated with said speed conference group;
said conferencing controller maintains a list of conference room identifiers including said predefined conference room identifier, each of said conference room identifiers being associated with a different one of a plurality of speed conference groups;
said processing circuitry provides said predefined conference room identifier to said conferencing controller upon receipt thereof from said first one of said conference participants; and
said conferencing controller is further operable to provide a third instruction to said processing circuitry to create said conference room based upon said predefined conference room identifier.

10. The conference server of claim 9, wherein said predefined conference room identifier includes a dialed-in number dialed by said first one of said conference participants.

11. The conference server of claim 1, wherein said processing circuitry is further operable to substantially simultaneously call said other ones of said conference participants to invite said other ones of said conference participants to join said conference call.

12. The conference server of claim 1, wherein said processing circuitry is further operable to separately mute audio between each of said other ones of said conference participants and said conference room until said other ones of said conference participants join said conference call.

13. The conference server of claim 1, wherein:
said processing circuitry is further operable to dial-out to said other ones of said conference participants, and upon connecting to each of said other ones of said conference participants, provide a prompt to join said conference call;
said processing circuitry further operating to connect each of said other ones of said conference participants to said conference room upon receiving an acceptance to join said conference call therefrom.

14. The conference server of claim 1, wherein said event includes a trigger received from an external system.

15. A system facilitating speed conferencing, comprising:
a conference server including a conference room operable to manage a conference call between conference participants, at least a portion of said conference participants belonging to a speed conference group, said conference server operable to create said conference room and to call said conference participants within said speed conference group to invite said conference participants to join said conference call upon the occurrence of an event; and
a conferencing controller operable to maintain said speed conference group, said speed conference group including a list of user identifications identifying at least a portion of said conference participants within said speed conference group, said conferencing controller being further operable to provide an instruction to said conference server to call said conference participants within said speed conference group using said respective user identifications associated therewith.

16. The system of claim 15, wherein said user identifications include at least one of user names and user telephone numbers, each of said user names being mapped to at least one of said user telephone numbers.

17. The system of claim 15, wherein:
said event includes receiving an incoming call at said conference server from a first one of said conference participants;
said conference server is operable to receive a first user identification from said first one of said conference participants and to provide said first user identification to said conferencing controller; and
said conferencing controller is further operable to compare said first user identification with said list to determine whether said first user identification is within said list, and if so, provide a first instruction to said conference server to call other ones of said conference participants within said speed conference group using said respective user identifications associated therewith to join said other ones of said conference participants to said conference call with said first one of said conference participants.

18. The system of claim 17, wherein:
said conference server is further operable to receive a group identifier identifying said speed conference group from said first one of said conference participants and to provide said group identifier to said conferencing controller;
said conferencing controller is further operable to use said group identifier to access said list; and
said conferencing controller is further operable to provide a second instruction to said conference server to call each of said conference participants within said speed conference group using said respective user identifications associated therewith when said first user identification is not within said list to join said conference participants within said speed dial group and said first one of said conference participants to said conference call.

19. The system of claim 18, wherein:
said group identifier is a predefined conference room identifier that identifies said conference room associated with said speed conference group;
said conferencing controller maintains a list of conference room identifiers including said predefined conference room identifier, each of said conference room identifiers being associated with a different one of a plurality of speed conference groups;
said conference server provides said predefined conference room identifier to said conferencing controller upon receipt thereof from said first one of said conference participants; and
said conferencing controller is further operable to provide a third instruction to said processing circuitry to create said conference room based upon said predefined conference room identifier.

20. A method for facilitating speed conferencing, comprising:
provisioning a speed conference group including conference participants;
receiving an incoming call from a first one of said conference participants;
creating a conference room for a conference call involving said conference participants of said speed conference group in response to said incoming call;
calling other ones of said conference participants within said speed conference group to invite said other ones of conference participants to join said conference call; and
joining said first one of said conference participants and said other ones of said conference participants to said conference call via said conference room.
